(19) United States
(12) Patent Application Publication
(10) Pub. No.: US 2012/0198981 A1
(43) Pub. Date: Aug. 9, 2012

(54) SUBSTRATE CUTTING APPARATUS AND METHOD OF CUTTING SUBSTRATE USING THE SAME

(76) Inventors: Masaaki SOFUE, Gyeonggi-do (KR); Young-kyung Kim, Gyeonggi-Do (KR)

(21) Appl. No.: 13/347,465

(22) Filed: Jan. 10, 2012

(30) Foreign Application Priority Data
Feb. 9, 2011 (KR) 10-2011-011611

(51) Int. Cl. B26D 9/00

(52) U.S. Cl. 83/862

(57) ABSTRACT

A substrate cutting apparatus and a method of cutting a substrate using the same. The substrate cutting apparatus includes: a stand that supports a substrate; a support that is movable up and down, presses the substrate toward the stand, and has a groove forming unit that form grooves corresponding to positions where the substrate is to be cut at an interval; and a cutting unit that is formed in the support to be movable up and down and cuts the substrate using the grooves formed by the groove forming unit. According to the substrate cutting apparatus, V-shaped grooves are formed in advance of cutting a substrate into unit substrates at portions to be cut. Thus, breaking of the substrate may be prevented during the cutting.

### CROSS-REFERENCE TO RELATED APPLICATIONS

This application claims the benefit of Korean Patent Application No. 10-2011-0011611, filed on Feb. 9, 2011, in the Korean Intellectual Property Office, the disclosure of which is incorporated herein in its entirety by reference.

### BACKGROUND

1. Field

The present disclosure relates to a substrate cutting apparatus and a method of cutting a substrate using the same, and more particularly, to an apparatus for cutting a metal core printed circuit board (MCPCB) by which less broken pieces are produced, and a method of cutting an MCPCB using the apparatus.

2. Description of the Related Art

In general, a metal core printed circuit board (MCPCB) is formed by forming a heat-dissipating resin layer on a surface of a metal substrate and forming an electrical circuit thereon. The heat-dissipating resin layer provides electrical insulation and dissipates heat from electronic parts to the metal substrate, and thermal conductivity thereof is increased by using a filler such as aluminum oxide (Al₂O₃) and glass fiber. Although thermal conductivity is generally in a range of 0.1 to 0.4 W/mK, the heat-dissipating resin has a thermal conductivity in a range of 0.5 to 20 W/mK.

However, the heat-dissipating resin layer is brittle due to the filler and breaks during a cutting process, and thus contaminants such as dust or broken pieces are produced. Thus, the contaminants produced during the cutting process should be discarded.

A general MCPCB cutting device includes a die on which an MCPCB base plate is mounted, a stripper that is disposed over the die and presses the MCPCB base plate toward the die, and a punch that is installed at one portion of the stripper to be movable up and down and cuts the MCPCB base plate into individual MCPCBs. The MCPCB base plate moves on the die at a constant speed, and the punch cuts the MCPCB base plate into individual MCPCBs while moving up and down.

In such a general MCPCB cutting device, a heat-dissipating resin layer of the MCPCB base plate is disposed at a side of the MCPCB base plate facing the punch. An individual MCPCB obtained by using the punch has a cut surface that is sharp. However, at a cut surface of the MCPCB base plate, the heat-dissipating resin layer is damaged due to tensile stress caused by warpage when the punch presses the MCPCB base plate.

That is, although the heat-dissipating resin layer of the cut surface of the individual MCPCB is not damaged, the heat-dissipating resin layer of the cut surface of the MCPCB base plate is damaged.

Therefore, a scrap portion having a width of around 2.5 mm is prepared in the MCPCB base plate between the individual MCPCBs for the damaged portions of the MCPCB base plate. Due to this scrap portion, manufacturing costs are increased.

### SUMMARY

Provided is are a substrate cutting apparatus that forms grooves at positions of an MCPCB base plate to be cut and cuts the grooves, whereby scraps are not produced while cutting the substrate, and thus manufacturing costs are reduced, and a method of cutting a substrate using the substrate cutting apparatus.

Additional aspects will be set forth in part in the description which follows and, in part, will be apparent from the description, or may be learned by practice of the presented embodiments.

According to an aspect of the present invention, a substrate cutting apparatus includes: a stand that supports a substrate; a support that is movable up and down, presses the substrate toward the stand, and has a groove forming unit that form grooves at an interval corresponding to positions where the substrate is to be cut; and a cutting unit that is formed in the support to be movable up and down and cuts the substrate using the grooves formed by the groove forming unit.

The groove forming unit may include a plurality of notches protruding from the support and spaced apart from each other at an interval, wherein one of the notches has a height greater than the other notches.

A notch closer to the cutting unit may have a height greater than the other notches.

The substrate may be a metal core printed circuit board (MCPCB) base plate including a metal layer and an insulating layer.

A depth of a groove formed on the MCPCB base plate may be twice a height of the insulating layer.

The plurality of notches may have a V (wedge) shape, and an angle of the V (wedge) shape may be in a range of 30 to 70 degrees.

The substrate may slide on the stand toward the cutting unit, wherein a depth of one groove closer to the cutting unit than the other grooves is greater than that of the other grooves.

The substrate cutting apparatus may further include an ejector that is formed in the stand to correspond to the cutting unit and is movable up and down so as to support and eject a portion of the substrate cut by the cutting unit.

According to another aspect of the present invention, a method of cutting a substrate using the substrate cutting apparatus includes: mounting the substrate on a stand; forming a plurality of grooves corresponding to positions where the substrate is to be cut on one surface of the substrate at an interval; and cutting the substrate divided by the plurality of grooves at the positions where the substrate is to be cut.

The forming the plurality of grooves may include: pressing an upper surface of the substrate using the support toward the stand to form the plurality of grooves on the substrate; separating the support from the substrate; moving the substrate toward the cutting unit by a length corresponding to a width of a portion of the substrate to be cut; and deepening the plurality of grooves by moving the support downward.

The method may further include forming a plurality of grooves having a predetermined depth on another surface of the substrate and corresponding to the plurality of grooves formed on the one surface of the substrate.

The substrate may be an MCPCB base plate including a metal layer and an insulating layer formed on the metal layer.

A depth of a groove may be twice a height of the insulating layer.

The grooves may have a V shape, and an angle of the grooves may be in a range of 30 to 70 degrees.

The cutting the substrate may be performed by pressing the grooves downward.

### BRIEF DESCRIPTION OF THE DRAWINGS

These and/or other aspects will become apparent and more readily appreciated from the following description of the embodiments, taken in conjunction with the accompanying drawings of which:

FIG. 1 is a cross-sectional view schematically illustrating a substrate cutting apparatus according to an embodiment of the present invention;

FIGS. 2 to 6 are cross-sectional views for describing a method of forming a plurality of grooves on one surface of a substrate and cutting the substrate using the substrate cutting apparatus of FIG. 1;

FIG. 7 is a cross-sectional view of a substrate having a plurality of grooves formed on two surfaces of the substrate and corresponding to each other;

FIG. 8 is a photograph of a cross-section of a substrate on which a groove is formed by using the substrate cutting apparatus of FIG. 1; and

FIG. 9 is a photograph of a cut surface of the substrate of FIG. 8.

### DETAILED DESCRIPTION

Reference will now be made in detail to embodiments, examples of which are illustrated in the accompanying drawings, wherein like reference numerals refer to like elements throughout. In this regard, the present embodiments may have different forms and should not be construed as being limited to the descriptions set forth herein. Accordingly, the embodiments are merely described below, by referring to the figures, to explain aspects of the present description.

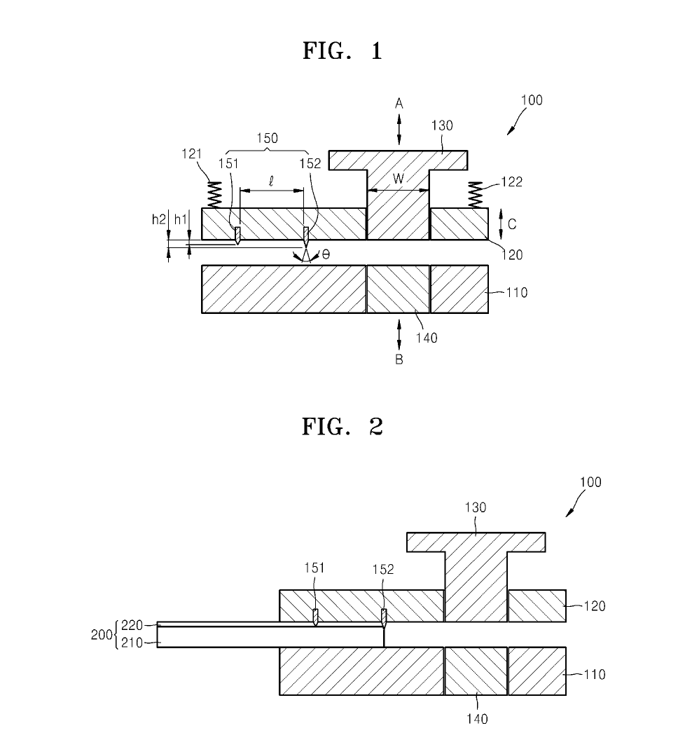

FIG. 1 is a cross-sectional view schematically illustrating a substrate cutting apparatus 100 according to an embodiment of the present invention;

Referring to FIG. 1, the substrate cutting apparatus 100 is an apparatus for cutting a substrate base plate, for example, a metal core printed circuit board (MCPCB) base plate, into a plurality of unit substrates and includes a stand 110, a support 120, a cutting unit 130, an ejector 140, and a groove forming unit 150.

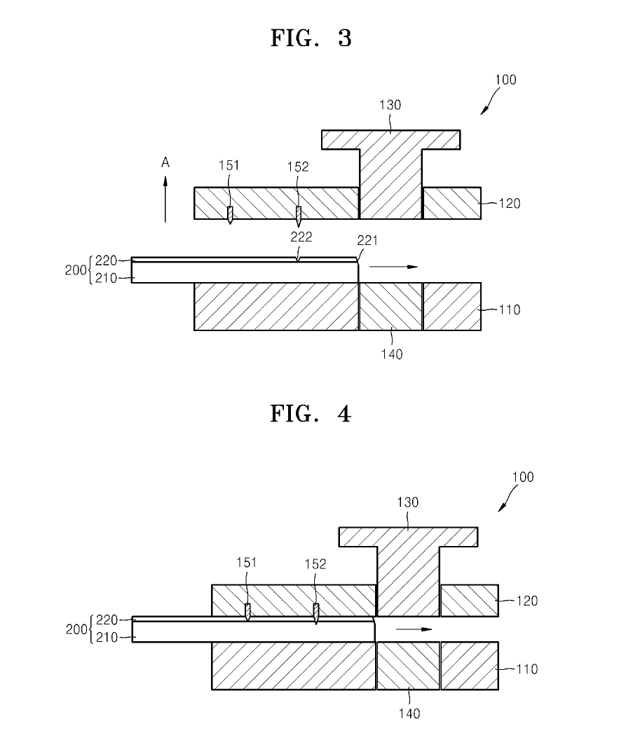

The stand 110 is fixed and supports a substrate 200 (FIG. 2) that is to be mounted thereon. The substrate 200 (FIG. 2) slides on the stand 110 toward the cutting unit 130.

The support 120 is disposed over the stand 110 by a plurality of elastic units 121 and 122, e.g., springs, to be downwardly movable and moves up and down (as shown with an arrow C) with respect to the stand 110 by a lifting unit (not shown). Thus, the support 120 may press the substrate 200 (FIG. 2) mounted on the stand 110 or be spaced apart from the substrate 200 according to an operation process.

The cutting unit 130 cuts the substrate 200 (FIG. 2) into the unit substrates. For this, the cutting unit 130 is movable up and down (as shown with an arrow A) with respect to the support 120 by a lifting unit (not shown). Since the cutting unit 130 moves dependently with the support 120, the cutting unit 130 moves up and down while the support 120 moves up and down. Thus, the cutting unit 130 moves along with the support 120 while the support 120 moves up and down and also moves up and down with respect to the support 120.

The ejector 140 is disposed in the stand 110 to move up and down (as shown with an arrow B) and supports and ejects the unit substrates cut by the cutting unit 130. Accordingly, the ejector 140 is disposed to correspond to the cutting unit 130 and has a width equal to or greater than that of the cutting unit 130 (FIG. 1).

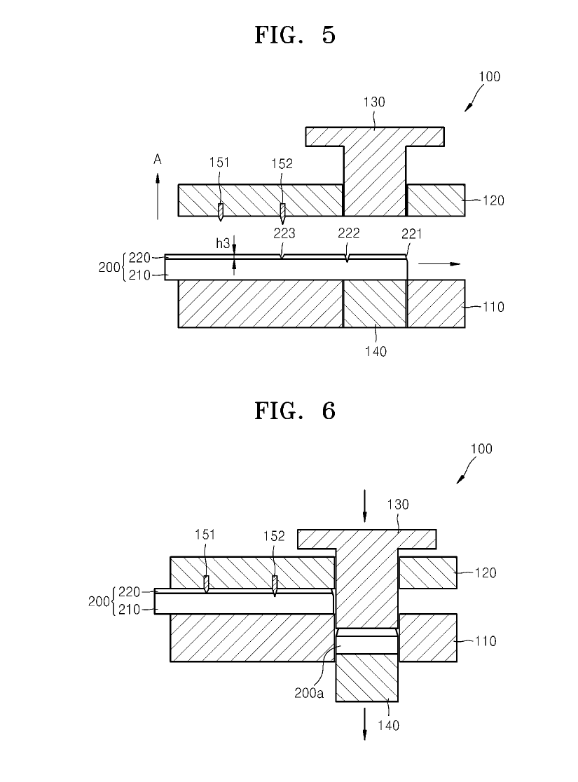

The groove forming unit 150 is formed on a lower surface of the support 120 to protrude toward the stand 110 by a predetermined height, so as to form V-shaped grooves 221, 222, 224, and 225 of FIG. 7 in the substrate 200 (FIG. 2). The groove forming unit 150 includes a first notch 151 and a second notch 152.

The first notch 151 and the second notch 152 are spaced apart from each other at an interval λ and fixed to the support 120. The interval λ between the first notch 151 and the second notch 152 corresponds to a width of the unit substrates cut from the substrate 200 (FIG. 2) or a width w of the cutting unit 130 (*w is unmarked in the figures). Meanwhile, the second notch 152 is spaced apart from the cutting unit 130 by a predetermined distance. The distance between the second notch 152 and the cutting unit 130 may be the same as the interval λ between the first notch 151 and the second notch 152. The first notch 151 and the second notch 152 may be fixed to the support 120 by making a hole (not shown) in the support 120 and then inserting the first notch 151 and the second notch 152 into the hole, or forming screw threads in the hole, on the first notch 151, and on the second notch 152 and screw-combining the hole with the first notch 151 and the second notch 152.

A height h2 of the second notch 152 protruding from the support 120 is greater than a height h1 of the first notch 151 protruding from the support 120. Accordingly, when the substrate 200 (FIG. 2) slides on the stand 110, a V-shaped groove formed by the first notch 151 and having a depth identical to the height h1 is deepened by the second notch 152 to have a depth identical to the height h2. That is, a groove formed in the substrate 200 (FIG. 2) by the first notch 151 is deepened by the second notch 152, resulting in the depth h2.

As such, V-shaped groove formed in the substrate is gradually deepened by using a plurality of notches having different heights, so that abrasion of one notch is dispersed. Thus, lifespan of a notch may be increased, and costs for maintaining the substrate cutting apparatus 100 may be reduced. Therefore, the number of notches is not limited to as shown in FIG. 1 and may vary.

The substrate 200 (FIG. 2), as an MCPCB base plate, includes a metal layer 210 and an insulating layer 220 formed on the metal layer 210. A V-shaped groove may have a depth that is twice a thickness h3 (FIG. 5) (*unmarked in the figure) of the insulating layer 220. Thus, the height h2 of the second notch 152 may be twice the thickness h3 (FIG. 5) of the insulating layer 220.

The first notch 151 and the second notch 152 may be formed at an angle θ in a range of 30 to 70 degree. As a result of experiments, if a notch is formed at an angle less than 30 degree, the notch deforms and breaks after hundreds of cuttings. If a notch is formed at an angle greater than 90 degree, a length of the unit substrates decreases due to too large a portion being cut and the unit substrates may be deformed due to high pressure applied by the cutting unit 130.

FIGS. 2 to 6 are cross-sectional views for describing a method of forming a plurality of grooves on one surface of the substrate 200 and cutting the substrate 200 using the substrate cutting apparatus of FIG. 1. FIG. 7 is a cross-sectional view of the substrate 200 having a plurality of grooves formed on two surfaces of the substrate 200 and corresponding to each other. The substrate cutting apparatus 100 has the structure shown in FIG. 1, although the springs 121 and 122 shown in FIG. 1 are not shown for descriptive convenience.

First, referring to FIG. 2, the substrate 200 is mounted on the stand 110. The substrate 200 may be an MCPCB base plate including the metal layer 210 and the insulating layer 220 formed on the metal layer 210 and having a predetermined thickness. The substrate 200 is aligned such that the second notch 152 installed in the support 120 faces one end of the substrate 200. Then, the substrate 200 is pressed by moving the support 120 downward to dig the first notch 151 and the second notch 152 into an upper surface of the substrate 200. In this regard, in the substrate 200, the V-shaped groove 221 (FIG. 3) having the depth h2 (FIG. 1) is formed by the second notch 152, and the V-shaped groove 222 (FIG. 3) having the depth h1 (FIG. 1) is formed by the first notch 151.

Referring to FIG. 3, the support 120 is separated from the substrate 200 by moving the support 120 upward. Then, the substrate 200 is moved toward the cutting unit 130. In this regard, a distance that the substrate 200 is moved is the same as the interval λ between the first notch 151 and the second notch 152.

Referring to FIG. 4, the substrate 200 is pressed by moving the support 120 downward to contact the first notch 151 and the second notch 152 with the substrate 200. In this regard, the second notch 152 contacts with the groove 222 (FIG. 5) and makes the groove 222 (FIG. 5) have the depth h2 (FIG. 1), and the first notch 151 forms a new groove 223 (FIG. 5) having the depth h1 (FIG. 1) on the substrate 200. The grooves 221 and 222 having the depth h2 and formed on the substrate 200 divide the substrate 200 into unit substrates 200a (FIG. 6) that are cut by the cutting unit 130.

Referring to FIG. 5, the support 120 is separated from the substrate 200 by moving the support 120 upward. Then, the substrate 200 is moved toward the cutting unit 130. In this regard, the distance the substrate 200 is moved is the same as the interval (λ) between the first notch 151 and the second notch 152. Then, the unit substrate 200a divided by the grooves 221 and 222 is disposed below the cutting unit 130.

Referring to FIG. 6, the substrate 200 is pressed by moving the support 120 downward to contact the first notch 151 and the second notch 152 with the substrate 200. In this regard, an operation of forming grooves using the first notch 151 and the second notch 152 is the same as that described with reference to FIG. 4. Thus, descriptions thereof will be omitted herein.

When the cutting unit 130 is moved downward, the unit substrate 200a divided by the grooves 221 and 222 is cracked off and thus cut from the substrate 200. The cut unit substrate 200a is moved downward with the ejector 140 while being supported by the ejector 140.

Then, although not shown herein, the cutting unit 130 and the ejector 140 return to their positions, and the cut unit substrate 200a is removed. Then, the unit substrates 200a are sequentially separated from the substrate 200 by repeating the operations described with reference to FIGS. 2 to 6.

Meanwhile, referring to FIG. 7, the plurality of grooves 221, 222, 224, and 225 may be formed on the upper surface and a lower surface of the substrate 200 to correspond to each other. In other words, as shown in FIGS. 3 and 5, the grooves 221 and 222 are formed on the upper surface of the substrate 200, and the grooves 224 and 225 are formed on the lower surface of the substrate 200 to correspond to the grooves 221 and 222. First, the grooves 221 and 222 are formed on the substrate 200 by performing the operation described with reference to FIGS. 2 to 5, and the substrate 200 is turned over. Then, the grooves 224 and 225 are formed on the substrate 200 by repeating the operations described with reference to FIGS. 2 to 5. As such, by forming the grooves 221, 222, 224, and 225 on the upper and lower surfaces of the substrate 200, the unit substrates may be more efficiently separated.

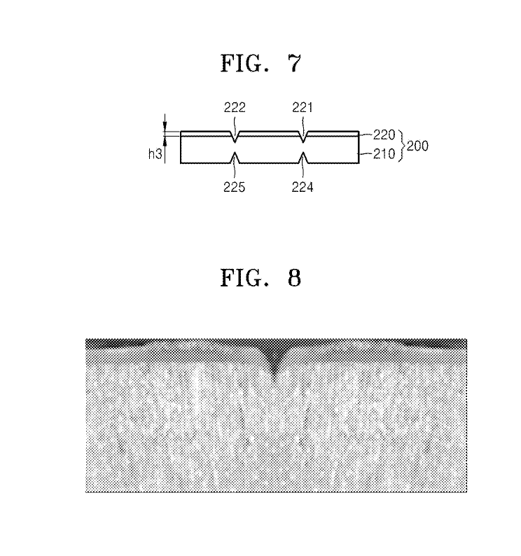

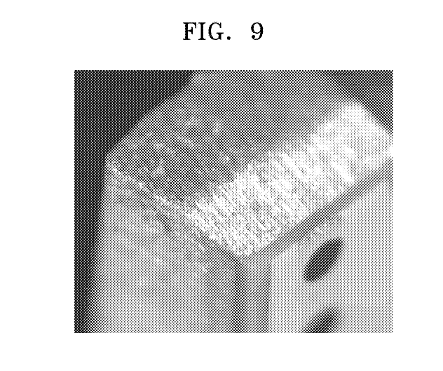

FIG. 8 is a photograph of a cross-section of a substrate on which a groove is formed by using the substrate cutting apparatus 100 of FIG. 1. FIG. 9 is a photograph of a cut surface of the substrate of FIG. 8.

Referring to FIGS. 8 and 9, if a V-shaped groove is formed by using the substrate cutting apparatus 100 according to an embodiment of the present invention, an insulating layer is pressed in the V-shaped groove, resulting in slight swelling, and a metal layer is slightly warped. However, the warpage does not become serious, and the substrate may be safely processed.

According to the substrate cutting apparatus and the method of cutting a substrate according to the present invention, V-shaped grooves are formed in advance of cutting a substrate into unit substrates at portions to be cut. Thus, breaking of the substrate may be prevented during the cutting. In addition, since the substrate is prevented from breaking, scraps may not be produced. Thus, manufacturing costs may be reduced. If the substrate is an MCPCB base plate, breaking of an insulating layer may be prevented.

It should be understood that the exemplary embodiments described therein should be considered in a descriptive sense only and not for purposes of limitation. Descriptions of features or aspects within each embodiment should typically be considered as available for other similar features or aspects in other embodiments.

What is claimed is:

1. A substrate cutting apparatus comprising:
a stand that supports a substrate;
a support that is movable up and down, presses the substrate toward the stand, and has a groove forming unit that form grooves at an interval corresponding to positions where the substrate is to be cut; and
a cutting unit that is formed in the support to be movable up and down and cuts the substrate using the grooves formed by the groove forming unit.

2. The substrate cutting apparatus of claim 1, wherein the groove forming unit comprises a plurality of notches protruding from the support and spaced apart from each other at an interval, wherein one of the notches has a height greater than the other notches.

3. The substrate cutting apparatus of claim 2, wherein a notch closer to the cutting unit has a height greater than the other notches.

4. The substrate cutting apparatus of claim 3, wherein the substrate is a metal core printed circuit board (MCPCB) base plate comprising a metal layer and an insulating layer.

5. The substrate cutting apparatus of claim 4, wherein a depth of a groove formed on the MCPCB base plate is twice a height of the insulating layer.

6. The substrate cutting apparatus of claim 2, wherein the plurality of notches have a V (wedge) shape, and an angle of the V (wedge) shape is in a range of 30 to 70 degrees.

7. The substrate cutting apparatus of claim 2, wherein the substrate slides on the stand toward the cutting unit, wherein a depth of one groove closer to the cutting unit than the other grooves is greater than that of the other grooves.

8. The substrate cutting apparatus of claim 1, further comprising
an ejector that is formed in the stand to correspond to the cutting unit and is movable up and down so as to support and eject a portion of the substrate cut by the cutting unit.

9. A method of cutting a substrate using the substrate cutting apparatus of claim 3, the method comprising:
mounting the substrate on a stand;
forming a plurality of grooves corresponding to positions where the substrate is to be cut on one surface of the substrate at an interval; and
cutting the substrate divided by the plurality of grooves at the positions where the substrate is to be cut.

10. The method of claim 9, wherein the forming the plurality of grooves comprises:
pressing an upper surface of the substrate using the support toward the stand to form the plurality of grooves on the substrate;
separating the support from the substrate;
moving the substrate toward the cutting unit by a length corresponding to a width of a portion of the substrate to be cut; and
deepening the plurality of grooves by moving the support downward.

11. The method of claim 9, further comprising forming a plurality of grooves having a predetermined depth on another surface of the substrate and corresponding to the plurality of grooves formed on the one surface of the substrate.

12. The method of claim 9, wherein the substrate is an MCPCB base plate comprising a metal layer and an insulating layer formed on the metal layer.

13. The method of claim 12, wherein a depth of a groove is twice a height of the insulating layer.

14. The method of claim 13, wherein the grooves have a V shape, and an angle of the grooves is in a range of 30 to 70 degrees.

15. The method of claim 9, wherein the cutting the substrate is performed by pressing the grooves downward.
